(19) United States
(12) Patent Application Publication
(10) Pub. No.: US 2020/0062425 A1
(43) Pub. Date: Feb. 27, 2020

(54) SUPPORT DEVICE FOR MANIPULATING A LOAD

(71) Applicant: Mark Baird, Alameda, CA (US)

(72) Inventor: Mark Baird, Alameda, CA (US)

(21) Appl. No.: 16/547,238

(22) Filed: Aug. 21, 2019

Related U.S. Application Data
(60) Provisional application No. 62/721,225, filed on Aug. 22, 2018.

(51) Int. Cl. B64F 5/50; F16M 11/04; F16M 11/06

(52) U.S. Cl. CPC B64F 5/50; F16M 11/42; F16M 11/06; F16M 11/048

(57) ABSTRACT

The current invention comprises a support device for securing and manipulating a load. This support device specializes in manipulating aircraft components or other low-density loads. The preferred embodiment of the support device consists of a chassis having at least one load bearing arm to which a spring is attached, the spring being further connected to a grasp which releasably secures the load. The grasp, in the preferred embodiments, is either a standard spring clamp or an offset grasp. Multiple support devices may be employed to secure larger aircraft components or larger low-density loads.

### CROSS-REFERENCE TO RELATED APPLICATIONS

The present application claims the benefit of Provisional Patent Application No. 62/721,225, filed on Aug. 22, 2018, the content of the application is hereby incorporated by reference in its entirety.

### FIELD OF THE INVENTION

The current invention relates generally to devices for manipulating loads, and more specifically to devices for manipulating aircraft components.

### BACKGROUND OF THE RELATED ART

There are occasions during assembly and disassembly of mechanical structures where precise manipulation of a load is necessary to avoid damage. Further complicating this precise manipulation is the size and configuration of the load. For example, during aircraft engine maintenance, the engine cowlings must be precisely manipulated across a large range of motion while avoiding larger obstructing elements, such as the propeller or landing gear. To solve this problem, two people are often used during the disassembly process, providing the necessary support to the load to avoid damage.

The relevant task is not to assist supporting or lifting the weight of the load or aircraft component, but to overcome the component's size or configuration. Virtually all existing supports and hoists are designed to overcome weight as their principal function, and only provide placement, location, and orientation as secondary features. Employing these existing supports to manipulate a load falls short for several reasons, including imprecise control, inadequate load attachment points, the expense of common supports such as cherry pickers or forklifts, storage space limitations, and training and certification requirements to operate such supports.

Load in the context of this invention shall be understood to mean either aircraft components or any components comprising a low-density material. Low-density shall mean any density at or below the density of steel, including, but not limited to, such materials as aluminum, titanium, and various wood and wood composites. The low-density components may include high-density features, so long as the overall load density remains below that of steel.

The main related art consists of employing additional people to assist component handling and abandons attempts to accomplish it single-handedly. However, when all support is provided by people, instead of machinery, stability and precise location of the component is impossible because human support can only be sustained for a short duration. Moreover, at smaller airports or shops there is simply no other person available to assist in component handling. Therefore, what is needed is a modular and easy to transport device which can be used by a solo mechanic to support a load.

### SUMMARY OF THE INVENTION

The preferred embodiment of the current invention comprises a chassis, with or without masts, load bearing arms, a spring, grasp, and—in certain embodiments—an offset grasp. These features are present in the preferred embodiment, but the claimed invention is not so limited as to require all above-mentioned elements and is solely limited by the claimed features.

At the base of the current invention is a chassis. In the preferred embodiment, the chassis is H-shaped, having two sides of equal length and a chassis brace connecting the two sides. The chassis' width is narrower than its length. Also, in the preferred embodiment are a plurality of masts which rise from the chassis and are separated by a width, the number of masts depending on the intended use of the support device. In another embodiment, the chassis may be directly connected to the load bearing arms. The chassis' shape enables placement of the chassis nearer to the desired load, avoiding interference between the mast and any obstacle.

In the preferred embodiment, the chassis also incorporates a cross brace interposed between the chassis and mast to prevent distortion, and a plurality of wheels to increase mobility. Employing a cross brace raises the current invention's resistance to tipping when attached to a load. All bracing is placed lower on the masts so as to not interfere with the load bearing arms' movement along the length of the mast.

Each mast secures a plurality of load bearing arms. The load bearing arms extend out over the chassis, and the opposing force generated from this cantilever prevents the load and support device from tipping. The load bearing arms and the mast are collapsible and removable from the chassis to facilitate transport of the current invention by small vehicles and minimize the space needed to store the support device. Each load bearing arm can be moved freely up and down the mast and be locked at any selected position along the mast.

In an alternative embodiment the mast and/or load bearing arms incorporate an adjustment subsystem. An embodiment of the adjustment subsystem is a rotational device which allows the load bearing arms to swivel 360 degrees about the mast. In this embodiment, it is possible to orient the load bearing arms such that they suspend a load opposite the chassis instead of above the chassis. This is accomplished by securing a weight to the chassis which counterbalances a load attached to the load bearing arms. This orientation permits placement of the chassis such that it is not directly below the load, allowing the user to bypass any obstructions in the vicinity of the load.

In another embodiment, a ratchet mechanism may also serve as an adjustment subsystem by employing a ratchet to raise or lower the load bearing arms to any point along the length of the mast. The ratchet may incorporate free movement as well as ratcheted movement. The ratchet may be operated remotely or manually near the ratchet mounting point. In yet another embodiment, the load bearing arms feature a telescoping adjustment subsystem capable of locking a selected length.

Each load bearing arm may also be braced to the mast. The brace may be attached either to the top or bottom of the load bearing arm, facilitating movement of the posts along the mast by placing the cross brace in an alternate plane to the direction of movement. For example, the cross brace may be placed above the load bearing arm should the user desire to move the load bearing arm to its lowest position.

The grasp for securing the load or aircraft component may be made with cushioned spring clamps, a mechanical fastener, or by any similar means. In the preferred embodiment the grasp is offset from a standard clamp. A standard clamp in this context is a clamp wherein the actuator is colinear with the attachment point. In the offset variation, the actuator is non-colinear with the grasp, and is deflected from the standard colinear position by an offset angle. Colinear in this sense shall mean that the attachment point and the actuator midpoint are linearly aligned. The offset may range from 1 to 120 degrees, depending on the desired load. This offset permits the load to be secured such that any interference from the engine or an adjacent component is minimized or eliminated.

Other examples of an offset grasp include an offset grasp where the grasp of the offset grasp is separate from the attachment point, i.e. the offset grasp does not incorporate a hinged connection for the attachment point and the actuator. An example of this embodiment includes, but is not limited to, one where the attachment point is secured along the load bearing arm, while the actuator is a remote subsystem capable of controlling the attachment point.

The grasp may be rigidly attached to the end of the load bearing arm or attached with an interposing spring. The term spring is not to be limited to the traditional meaning of the word, but instead shall mean any apparatus which selectively secures the load bearing arm to the grasp. Examples include, but are not limited to, springs, straps, tubing, and rope. In the preferred embodiment, the spring comprises a length of rubber strapping. The spring permits small adjustments of the load to align it or shift it clear of any obstructions.

The current invention is sufficiently compact and light to permit several support devices to be combined as necessary to manipulate a single load or multiple loads. Utilizing multiple support devices to releasably support a load is best suited to loads which are sufficiently rigid to act as their own connection between the support devices. Using a pair of support devices secures a load from four points and enables tilting of the unwieldy component in two axes.

In practice, manually adjusting each load bearing arm directly produces better and faster positioning than remote positioning, however, other embodiments of the current invention may incorporate a remote positioning means. In another embodiment, screws and a motor means may replace the mast, the motor means raising or lowering the load bearing arms from a single location via a remote control module.

### BRIEF DESCRIPTION OF THE DRAWINGS

FIG. 1 is a perspective view of the current invention.

FIG. 2 is a zoomed perspective view of the load bearing arms.

FIG. 3 is a zoomed perspective view of the load bearing arms having an offset grasp.

FIG. 4 is a side view of the offset grasp.

FIG. 5. is a side view of a variation of the offset grasp.

FIG. 6. is a side view of a second variation of the offset grasp.

### DETAILED DESCRIPTION OF THE DRAWINGS

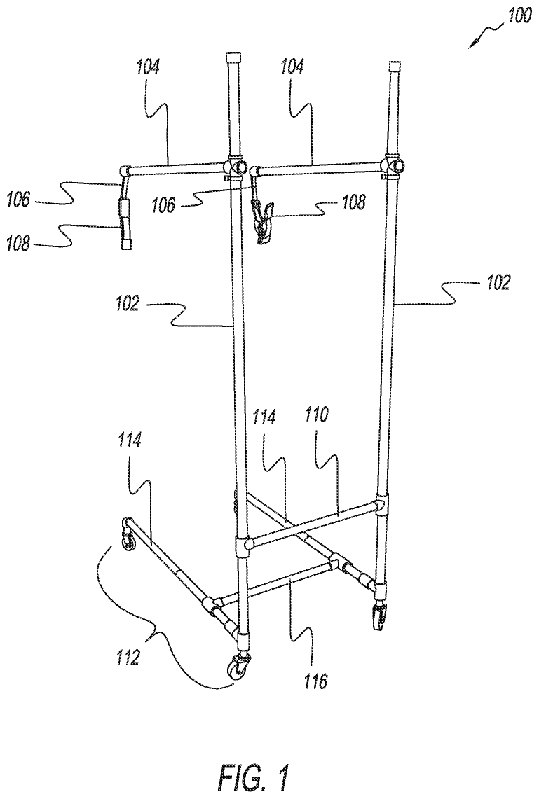

Shown in FIG. 1 is an embodiment of the support device 100. In the preferred embodiment, the chassis 112 consists of two side portions 114 releasably attached with a chassis brace 116 to form an “H” shape. Attached to the chassis 112 are a plurality of masts 102. In the preferred embodiment, two masts 102 are attached to the chassis 112. The “H” shaped chassis 112 permits the masts 102 to be offset from the chassis 112, creating a cantilever effect. The cantilever prevents the load from tipping the support device 100. Interposed between the masts 102 is a cross brace 110. In the preferred embodiment, the cross brace 110 is located approximately 12 inches above the lower end of each mast 102. The cross brace 110 prevents distortion of the masts 102 when the support device 100 is under load.

Located at the end of the mast 102 opposite the chassis 112 are a pair of load bearing arms 104. Attached to the load bearing arms 104 is a spring 106. In the preferred embodiment, the spring 106 consists of polymeric strapping. Connected to the spring 106 is a grasp 108. The spring 106 permits a load attached to the grasp 108 to be adjusted without needing to move the load bearing arms 104.

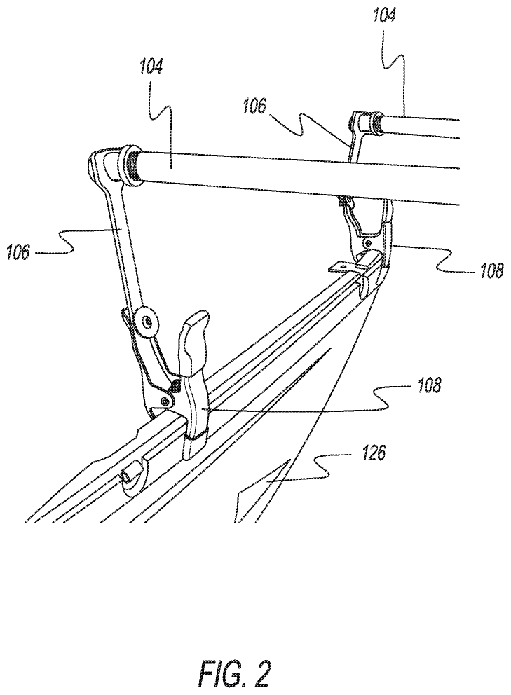

FIG. 2 shows the load bearing arm 104 portion of an embodiment of the current invention. In many instances, the cowling 126 cannot be supported from the bottom or sides, as securing the cowling 126 from these points causes interference between the cowling and the support device 100. To prevent interference with the cowling 126, the load bearing arms 104 are connected to the grasp 108 via a spring 106. The grasp 108, in this embodiment, is a standard spring-loaded clamp. The standard spring-loaded clamps configuration permits the grasp 108 to secure the cowling 126 from the top.

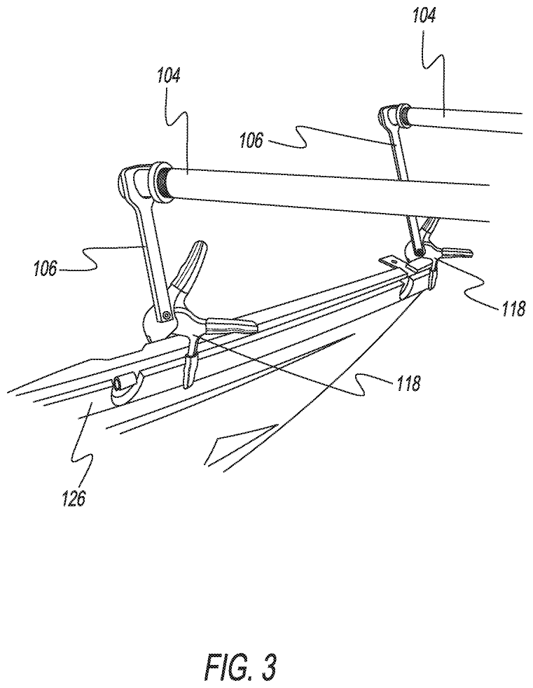

Shown in FIG. 3 is an embodiment of the support device 100 featuring an offset grasp 118. In this embodiment, the load bearing arms 104 are connected to one end of the spring 106. Connected to the opposite end of the spring 106 are the offset grasps 118.

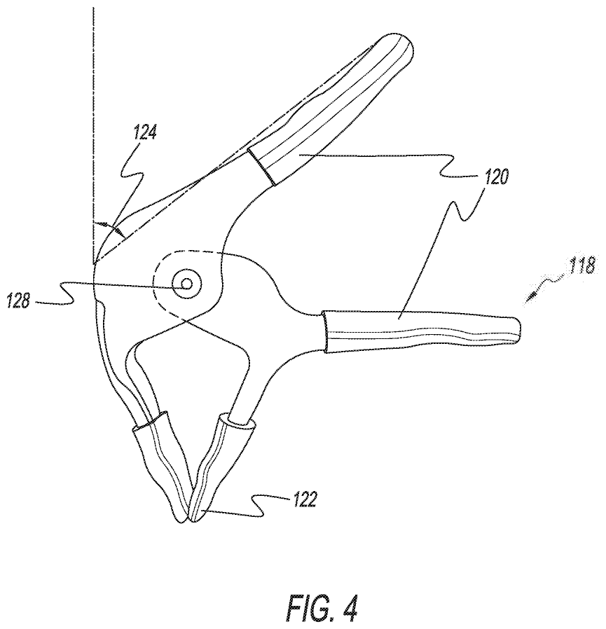

FIG. 4 shows a front view of the offset grasp 118. A key feature of the offset grasp 118 is that the attachment point 122 occupies a different vertical plane than the actuator 120. To achieve the plane offset the actuator 120 of the offset grasp 118 is offset from the axis of a standard clamp by the offset angle 124. The preferred offset angle 124 is between 60 and 100 degrees. The offset angle 124 enables the actuator 120 of the offset grasp 118 to avoid obstructions present on the aircraft or other structure.

The attachment point 122 of the offset grasp 118 is positioned opposite a hinge 128. The hinge 128, in concert with the actuator 120 and the attachment point 122, enable the user to operate the offset grasp 118 by applying pressure at the actuator 120. The orientation of the actuator 120 of the offset grasp 118 permits the offset grasp to secure a load from varying positions without causing interference with surrounding components.

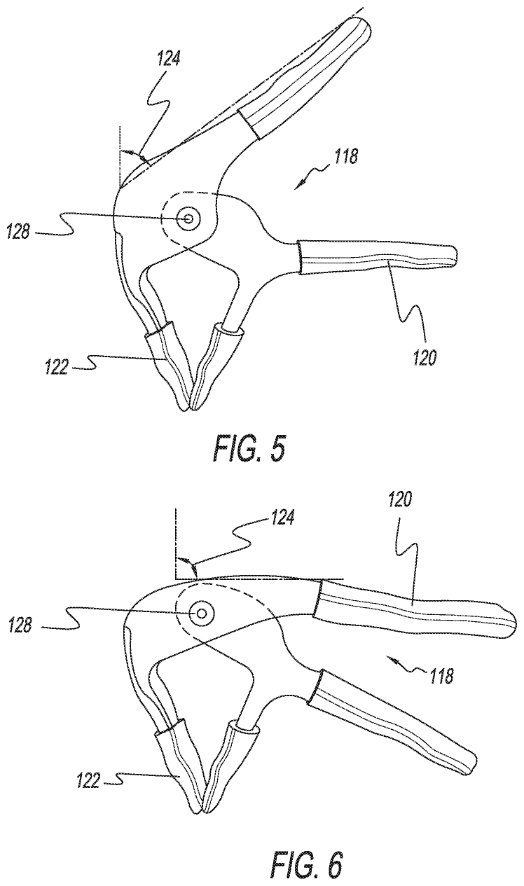

FIG. 5 and FIG. 6 show two versions of the offset grasp 118. FIG. 5 shows the first variant, wherein the offset angle 124 is approximately 75 degrees. Other embodiments of the offset grasp 118 incorporate a larger offset angle 124. The larger offset angle 124 is shown in FIG. 6. In this embodiment, the offset angle 124 of the offset grasp 118 is 90 degrees. In other embodiments, the offset angle 124 can be increased to 120 degrees.

I claim:

1. A support device comprising:
A chassis having at least one load bearing arm, a grasp having an attachment point and an actuator, the attachment point and the actuator being non-colinear, said grasp releasably attached to the load bearing arm, wherein the actuator facilitates releasable attachment of the attachment point.

2. The invention of claim 1 wherein the grasp incorporates a hinge in communication with the attachment point and the actuator.

3. The invention of claim 2 wherein the attachment point and the actuator are offset by between 1 to 120 degrees about the hinge.

4. The invention of claim 1 wherein the chassis further comprises at least one mast in communication with the chassis and the load bearing arm.

5. The invention of claim 4 wherein the mast further comprises an adjustment subsystem.

6. The invention of claim 5 wherein the adjustment subsystem is a rotational device that permits the load bearing arm to move about the mast by between 1 and 360 degrees.

7. The invention of claim 1 wherein the load bearing arm incorporates a spring in communication with the load bearing arm and the grasp.

8. A support device for a low-density component comprising:
A chassis having at least one load bearing arm, a grasp having an attachment point and an actuator, the attachment point and the actuator being non-colinear and hinged, said grasp releasably attached to the load bearing arm, wherein the actuator facilitates releasable attachment of the attachment point to the low-density component.

9. The invention of claim 8 wherein the attachment point and the actuator are offset by between 1 to 120 degrees about the hinge.

10. The invention of claim 8 wherein the load bearing arm incorporates a spring in communication with the load bearing arm and the grasp.

11. The invention of claim 8 wherein the chassis further comprises at least one mast in communication with the chassis and the load bearing arm.

12. The invention of claim 11 wherein the mast further comprises an adjustment subsystem.

13. The invention of claim 12 wherein the adjustment subsystem is a rotational device that permits the load bearing arm to move about the mast by between 1 and 360 degrees.

14. An aircraft component support device comprising:
A chassis having at least one load bearing arm, a grasp having an attachment point and an actuator, the attachment point and the actuator being non-colinear and hinged, said grasp releasably attached to the load bearing arm with a spring, wherein the actuator facilitates releasable attachment of the attachment point to the aircraft component.

15. The invention of claim 14 wherein the attachment point and the actuator are offset by between 1 to 120 degrees about the hinge.

16. The invention of claim 14 wherein the load bearing arms further comprise a telescoping means.

17. The invention of claim 14 wherein the spring material consists of rubber, metal, or plastic.

18. The invention of claim 14 wherein the chassis further comprises at least one mast in communication with the chassis and the load bearing arm.

19. The invention of claim 18 wherein the mast further comprises an adjustment subsystem.

20. The invention of claim 19 wherein the adjustment subsystem is a rotational device that permits the load bearing arm to move about the mast by between 1 and 360 degrees.
